(19) United States
(12) Patent Application Publication
(10) Pub. No.: US 2008/0198327 A1
(43) Pub. Date: Aug. 21, 2008

(54) Fusion improvement and training device fuziotren and method for use thereof

(76) Inventors: Igor Bursov, Moscow (RU); Skald Shapovalov, Moscow (RU); Evgeniy Skvortsov, Moscow (RU)

Correspondence Address: Aleksandr Smushkovich, P.O.Box 140505, Brooklyn, NY, 11214, US

(21) Appl. No.: 12/008,294

(22) Filed: Jan. 10, 2008

(30) Foreign Application Priority Data
Feb. 20, 2007 (RU) 2007106090/22

(51) Int. Cl. A61H 5/00

(52) U.S. Cl. 351/203

(57) ABSTRACT

A device for improvement and training the fusion reflex and method for use thereof are proposed. The method comprises providing the device, including substantially identical right and left photo-probes, each photo-probe including a base stand, supporting a vertical rod, with an aiming unit, light-emitting photo-targets of different colors, mounted on the rod, with predetermined distances therebetween and to the aiming unit, choosing a distant object, disposing the photo-probes in front of the person's eyes, closing the left eye, pointing the aiming means at the object, imposing a photo-targets' image, immediately under the object's image, opening the left eye, viewing real and phantom right photo-target images, positioned to the left from the real one, closing the right eye, and repeating the same steps for the right eye, opening both eyes, simultaneously repeating the same steps for both eyes; and repeating the aforesaid cycle a predetermined number of times.

### CROSS-REFERENCE TO RELATED APPLICATION

This U.S. patent application claims priority under 35 U.S.C. 119 (a) through (d) from a Russian Federation patent application No. 2007106090/22 filed on 20 Feb. 2007, now a Russian Federation Patent RU65757 published on 27 Aug. 2007. This application also contains newly disclosed parts.

### TECHNICAL FIELD

The present invention relates to the domain of medicine, particularly to opthalmology, and can be deployed for training and improvement of a binocular vision coupling reflex of human brain, also known and herein referred to as ‘fusion’.

### BACKGROUND OF THE INVENTION

There is known a device, called ‘Synoptofor’ (manufactured by the Kharkov device-construction factory, Ukraine, 1979), for testing fusion abilities of patients with impaired binocular vision in artificial gaploscopical conditions. ‘Synoptofor’ provides for presentation of two pictures: one—in front of the right eye, and the other—in front of the left eye, at a distance less than 5 cm from the eyes. It therefore allows determination of quantitative binocular vision characteristics for closely located objects, but not for far located objects.

There is known a fusional ‘Diploscope’ (Russian Federation Patent RU23760), including a support stand; a drive; a rack hingedly secured on the stand with guiding and measuring laths; three regulated light sources, the first source is secured in the center of the rack, the second and third sources are secured on carriages movable along the guiding lath of the rack; a red color filter is mounted on one of the ends of the rack. ‘Diploscope’ is designed for determination of a binocular vision zone for both closely and distantly located objects.

A portable device for evaluation of binocular vision problems is described in U.S. Pat. No. 5,764,340 that “measures the three vision parameters of stereoscopic vision, fusion testing, and fusion recovery measurement. The device comprises a stereo-pair of images in constant view through the eye pieces of a lighted View Master.RTM. slide viewer. Two viewers are utilized, with the viewers using identical “4-Dot” stereo pairs but differing in that the right and left images are transposed. A reel mount in the View-Master viewer is mounted with a graded series of neutral density filters, with the filters being arranged so that the filter density increases over one eye as the reel is advanced with a lever, until the color of the solid circle changes. Use of the two viewers permits ready identification of an eye with nerve conduction defect, with one viewer measuring right eye defects and the other measuring left eye defects.”

“A system, device within a system, and a method for enhancing visual perception in a two-dimensional image is disclosed” in U.S. Pat. No. 7,086,735, “providing the induction of retinal disparity in the viewer by a device with which the two-dimensional image is viewed. With fusion of the retinally disparate images of the two-dimensional image, the viewer experiences the enhancement of his or her visual perception in the two dimensional image, which includes enhancement of depth perception and enhancement in clarity perception.”

The above mentioned prior art devices and methods, though dealing with the fusion phenomenon, are intended for use in artificial gaploscopical conditions, and essentially do not allow for determination and improvement of the fusion reflex in the conditions of natural objects distantly or closely situated from the eyes.

In the prior art, gaploscopy is usually referred to as artificially dividing sight zones of the right and left eyes with presentation of essentially identical objects for observation. Conventional stereoscopes and stereoscopic images are based on gaploscopy.

### BRIEF DESCRIPTION OF THE INVENTION

The primary aims of the present invention are the improvement of natural fusion reflex for distantly or closely situated natural objects, training the fusion reflex, and treatment of people with binocular vision problems. These factors are very important for patients having impaired binocular vision, as well as for normal persons whose occupation requires high fusion abilities, e.g. aircraft pilots, and the like. Other aims of the invention might become apparent to those skilled in the art from a consideration of the drawings, ensuing description, and claims as hereinafter related.

The aforementioned aims are attained by providing a fusion improvement and training device “Fuziotren” and method for use thereof, disclosed herein below.

The inventive device comprises a pair of autonomous photo-probes, each photo-probe including a substantially vertical rod, supported by a base stand, preferably furnished with a handle.

Each photo-probe comprises an aiming unit, disposed in the top region of the rod, which aiming unit including a viewfinder and a dioptrical sight. Each photo-probe comprises a set of dotted monochromatic light-emitting photo-targets of different colors, mounted on the rod, and disposed at a predetermined distance below the aiming unit on the vertical line extending through the center of the aiming unit, and with predetermined distances between the photo-targets.

In preferred embodiments, the inventive device comprises two electric units, one of them is installed inside one of the base stands. Each of the electric units includes an accumulator battery, a switch, and a contact port.

The device comprises an adaptor for supplying direct electrical current to the contact ports, which adaptor allows charging the batteries. The adaptor is typically capable to be plugged into a conventional power grid socket. The batteries feed the aforesaid photo-targets.

### BRIEF DESCRIPTION OF DRAWINGS

FIG. 1 illustrates a general view of the inventive device in a preferred embodiment, including the adaptor connected to the contact ports of the photo-probes.

FIG. 2 illustrates a more detailed view of one of the photo-probes.

Identical reference numerals in the drawings generally refer to the same elements in different figures. A first-time introduced numeral in the description is enclosed into parentheses.

### DESCRIPTION OF AN EXEMPLARY EMBODIMENT OF THE INVENTION

While the invention may be susceptible to embodiment in different forms, there is shown in the drawings, and will be described in detail herein, a specific exemplary embodiment of the present invention, with the understanding that the present disclosure is to be considered an exemplification of the principles of the invention, and is not intended to limit the invention to that as illustrated and described herein.

### Fusion Improvement and Training Device

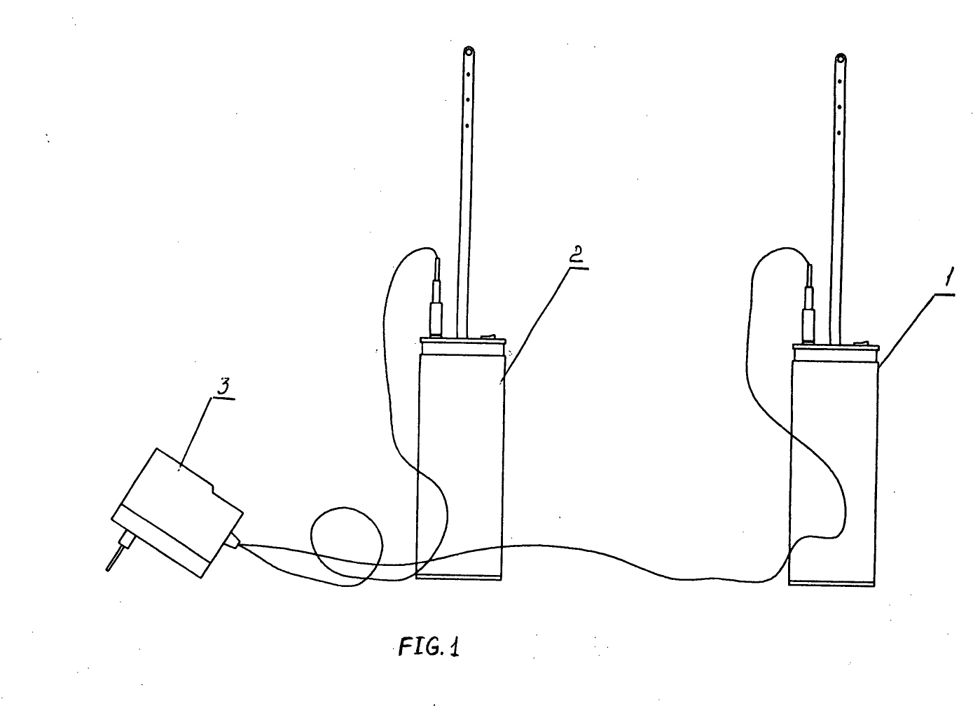

A preferred embodiment of the inventive device is depicted on FIG. 1, comprising a right photo-probe (1), a left photo-probe (2), and an adaptor (3) generally supplying direct electrical current to the photo-probes 1 and 2.

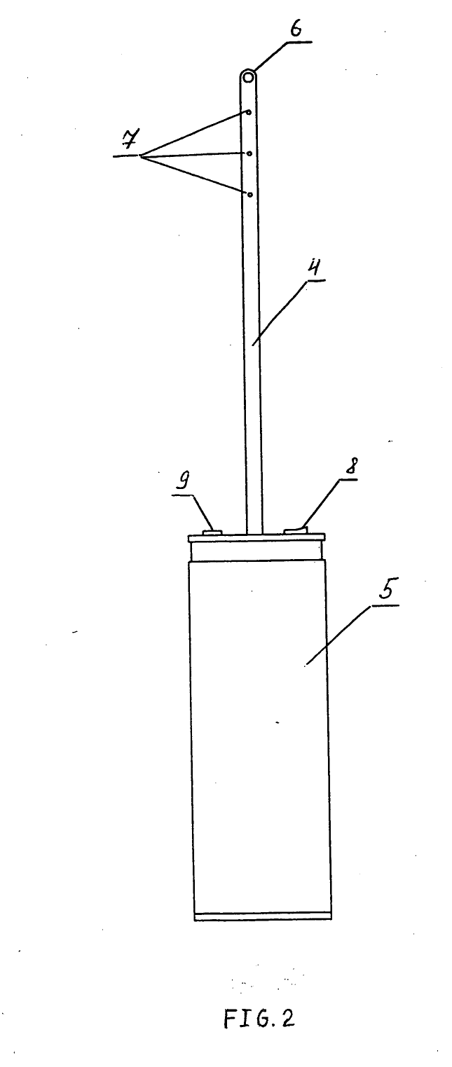

The photo-probes 1 and 2 are substantially identically designed. One of them (e.g. photo-probe 1) is shown on FIG. 2. The photo-probe 1 comprises a substantially vertical rod (4), supported by a base stand (5) conveniently furnished with a handle (not shown).

The photo-probe 1 comprises an aiming unit (6), disposed in the top region of the rod 4. The aiming unit 6 includes a viewfinder and a dioptrical sight (not shown in detail).

The photo-probe 1 comprises a set of dotted monochromatic light-emitting photo-targets (7) of different colors, mounted on the rod 4, and disposed at a predetermined distance below the aiming unit 6 on the vertical line extending through the center of the aiming unit 6 with predetermined distances between the photo-targets.

In this exemplary preferred embodiment, three photo-targets 7 are shown, the upper has the yellow color, the middle has the red color, and the lower has the green color. Preferably, the photo-targets 7 are performed as conventional light emitting diodes (LEDs). The upper diode is disposed preferably about 3 mm below the aiming unit 6. A preferable diameter of the LEDs is not exceeding 1 mm. A preferable distance between the upper diode and the middle diode, as well as between the middle diode and the lower diode, is substantially 6 mm.

The photo-probe 1 comprises an electric unit, installed inside the base stand 5. The electric unit includes an accumulator battery (not shown), a switch (8), and a contact port (9), connecting the battery to the adaptor 3 (shown on FIG. 1). The switch 8 and port 9 are situated on the top of the stand 5, though can be differently mounted in other embodiments.

The switch 8, when being turned on, supplies electric current from the battery to the photo-targets 7, and, when being turned off, disconnects the photo-targets 7 from the battery. The contact port 9 allows connecting the battery to the adaptor 3, whereas the latter can be plugged into a conventional alternative current power socket and can convert alternative current into direct current typically used by LEDs. Other power sources and circuits can be utilized in different embodiments for supplying electric current of suitable type and voltage to the photo-targets 7.

### Method of Operation of the Inventive Device

Step 1. A person, being tested for treatment or occupational purposes, chooses a distant object (e.g. a tree or the like located at 100 m through the window from which the object is seen), and disposes the right and left photo-probes 1 and 2 in front of the right and left eye respectively. The tested person turns on the switches 8 on the probes 1 and 2 and lights up the photo-targets 7 of the probes.

Step 2. The left eye is closed. Through the open right eye, the person points the aiming unit 6 of the right probe 1 at the distant object, and linearly imposes the photo-targets 7 of the probe 1, so that the photo-targets' image is positioned immediately under the distant object's image. Then she opens the left eye, and sees two images of the photo-targets: a real photo-target 7 coinciding with the vertical line of the right probe, and an imaginary (phantom) photo-target positioned outwardly from the left eye, that is to the left from the real photo-target of the probe 1. The images of photo-targets are seen similarly to an image of a vertically extended three-color streetlight.

Step 3. The right eye is closed. Through the open left eye, the person points the aiming unit 6 of the left probe 2 at the distant object, and linearly imposes the photo-targets 7 of the probe 2, so that the photo-targets' image is positioned immediately under the distant object's image. Then she opens the right eye, and sees two images of the photo-targets: a real photo-target 7 coinciding with the vertical line of the left probe, and an imaginary (phantom) photo-target positioned outwardly from the right eye, that is to the right from the real photo-target of the probe 2.

Step 4. The right and left eyes are open. Through the open right and left eyes substantially simultaneously, the person points the aiming unit 6 of the right probe 1 at the distant object linearly imposes the photo-targets 7 of the probe 1, so that the image of photo-targets of the probe 1 is positioned immediately under the distant object's image; and points the aiming unit 6 of the left probe 2 at the distant object, and linearly imposes the photo-targets 7 of the probe 2, so that the image of photo-targets of the probe 2 is positioned immediately under the distant object's image.

If the person has normal binocular vision, the images of real photo-targets 7 of probes 1 and 2 essentially coincide, and being viewed as a bright photo-target. The phantom photo-targets' images are positioned to the left and to the right from the real bright coincided photo-target's image. The right eye's phantom target image is viewed to the right from the real bright target image, and the left eye's phantom target image is viewed to the left from the real bright target image. Therefore, a ‘trident’ figure is viewed by the tested person, characterizing the normal fusion reflex for both eyes in the natural conditions.

Cycles of the aforesaid steps are repeated a number of times, which number is predetermined for each tested person during one training session. The number of sessions is also determined individually for each tested person.

Most of the times, the ‘training of the trident figure’ by the mentioned method allows improving (and sometimes forming) the fusion reflex for near and far objects in natural conditions, and develop binocular vision of patients and specialists, whose occupation sets up high requirements to the fusion reflex.

We claim:

1. A fusion improvement and training device comprising
a right photo-probe and a left photo-probe substantially identically designed, each said photo-probe including
a base stand;
a substantially vertical rod, supported by said stand;
an aiming means, disposed in the top region of said rod; and
a set of dotted monochromatic light-emitting photo-targets of different colors, mounted on said rod, and disposed at a predetermined distance below the aiming means on the vertical line extending through the center of said aiming means with predetermined distances between the photo-targets.

2. The fusion improvement and training device according to claim 1, wherein
said set consisting of three said photo-targets:
an upper photo-target having the yellow color,
a middle photo-target having the red color, and
a lower photo-target having the green color.

3. The fusion improvement and training device according to claim 1, wherein
said set consisting of three said photo-targets:
an upper photo-target disposed at 3 mm below the aiming means,
a middle photo-target disposed at 6 mm below said upper photo-target, and
a lower photo-target disposed at 6 mm below said middle photo-target.

4. The fusion improvement and training device according to claim 1, wherein
said photo-targets performed as light emitting diodes.

5. The fusion improvement and training device according to claim 4, wherein
said light emitting diodes having an equal diameter not exceeding 1 mm.

6. The fusion improvement and training device according to claim 1, further comprising
an adaptor capable of supplying direct electrical current of predetermined voltage, the adaptor being pluggable into a conventional electric grid socket;
wherein
each said photo-probe including an electric unit, each said electric unit installed inside the base stand, and including:
an accumulator battery connected to said photo-targets,
a contact port connectable to said adaptor thereby allowing to charge the battery, and
a switch switchably connecting said battery to said photo-targets.

7. A method for improvement and training the fusion reflex of a tested person, comprising the steps of:
a) providing a right photo-probe and a left photo-probe substantially identically designed, each said photo-probe including
a base stand;
a substantially vertical rod, supported by said stand;
an aiming means, disposed in the top region of said rod; and
a set of dotted monochromatic light-emitting photo-targets of different colors, mounted on said rod, and disposed at a predetermined distance below the aiming means on the vertical line extending through the center of said aiming means with predetermined distances between the photo-targets;
b) choosing a distant object by the tested person, disposing said right and left photo-probes in front of the person's right and left eyes respectively, lighting up said photo-targets;
c) closing the left eye, pointing the aiming means at the distant object, linearly imposing an image of said photo-targets, so that the photo-targets' image positioned immediately under the distant object's image, opening the left eye, viewing a real photo-target image of the right photo-probe coinciding with the vertical line of the right probe, and a phantom photo-target image positioned to the left from the real photo-target image of the right probe;
d) closing the right eye, pointing the aiming means at the distant object, linearly imposing an image of said photo-targets, so that the photo-targets' image positioned immediately under the distant object's image, opening the right eye, viewing a real photo-target image of the left photo-probe coinciding with the vertical line of the left probe, and a phantom photo-target image positioned to the right from the real photo-target image of the left probe;
e) opening the right and left eyes, pointing the aiming means of the right probe at the distant object, linearly imposing said photo-targets of the right probe, so that the image of photo-targets of the right probe positioned immediately under the distant object's image; and substantially simultaneously pointing the aiming means of the left probe at the distant object, and linearly imposing said photo-targets of the left probe, so that the image of photo-targets of the left probe positioned immediately under the distant object's image; and
f) repeating steps (a) through (e) a predetermined number of times.
